(19) United States
(12) Patent Application Publication
(10) Pub. No.: US 2024/0146086 A1
(43) Pub. Date: May 2, 2024

(54) MOBILE BATTERY CHARGING/RECHARGING SERVICE PROVIDED THROUGH A COMPUTING PLATFORM

(71) Applicant: Amulya Bhargava Harish, Fremont, CA (US)

(72) Inventor: Amulya Bhargava Harish, Fremont, CA (US)

(21) Appl. No.: 17/976,152

(22) Filed: Oct. 28, 2022

(51) Int. Cl. H02J 7/00

(52) U.S. Cl. CPC H02J 7/0071; H02J 7/00036; H02J 7/0048; H02J 7/007182

(57) ABSTRACT

A method includes detecting, through a first application executing on a first data processing device as a first component of a computing platform, a level of charge remaining in a battery of a power sink and, in response to the detection, identifying, through the first application, a mobile power source as compatible with the power sink based on dynamically tracking a change in location thereof via the computing platform in accordance with communication from a second application executing on a second data processing device as a second component of the computing platform. The method also includes automatically generating, through the first application via the computing platform, a transaction identifier identifying a service request from the first data processing device for charging or recharging the battery of the power sink through the mobile power source following the identification of the mobile power source as compatible with the power sink.

### FIELD OF TECHNOLOGY

This disclosure relates generally to battery charging/recharging systems and, more particularly, to a method, a server and/or a system of a mobile battery charging/recharging service provided through a computing platform.

### BACKGROUND

A user driving a vehicle (e.g., a car, a scooter, an electric bicycle, a hoverboard) may learn from viewing a dashboard thereof that a level of charge remaining on a battery thereof is low. There may be multiple battery service stations available for the user to recharge and/or replace the battery. However, even the closest service station may be far enough such that the vehicle may stall prior to reaching the destination thereof.

Another user may be carrying a mobile phone. The level of charge remaining on the mobile phone may be low, but the user may have forgotten to carry his/her phone charger and/or power bank. The user may thus be forced to borrow a compatible phone charger or a power bank based on repeatedly asking the same question to multiple personnel in a vicinity thereof. The process may not prove to be fruitful to the user.

### SUMMARY

Disclosed are a method, a server and/or a system of a mobile battery charging/recharging service provided through a computing platform.

In one aspect, a method includes detecting, through a first application executing on a first data processing device as a first component of a computing platform, a level of charge remaining in a battery of a power sink associated with the first data processing device, and dynamically tracking, through the computing platform, a change in location of a mobile power source based on communication with a second application executing on a second data processing device as a second component of the computing platform, with the second data processing device being associated with the mobile power source. The method also includes, in response to the detection of the level of charge remaining in the battery of the power sink, identifying, through the first application, the mobile power source as compatible with the power sink based on the dynamically tracked change in the location of the mobile power source via the computing platform, and automatically generating, through the first application via the computing platform, a transaction identifier identifying a service request from the first data processing device for charging or recharging the battery of the power sink through the mobile power source following the identification of the mobile power source as compatible with the power sink.

In another aspect, a server executing a computing platform includes a memory including instructions associated with the computing platform stored therein, and a processor communicatively coupled to the memory. The processor executes the instructions associated with the computing platform to detect, through a first application executing on a first data processing device as a first component of the computing platform, a level of charge remaining in a battery of a power sink associated with the first data processing device, and to dynamically track a change in location of a mobile power source based on communication with a second application executing on a second data processing device as a second component of the computing platform, with the second data processing device being associated with the mobile power source. The processor also executes the instructions associated with the computing platform to, in response to the detection of the level of charge remaining in the battery of the power sink, identify, through the first application, the mobile power source as compatible with the power sink based on the dynamically tracked change in the location of the mobile power source, and automatically generate, through the first application, a transaction identifier identifying a service request from the first data processing device for charging or recharging the battery of the power sink through the mobile power source following the identification of the mobile power source as compatible with the power sink.

In yet another aspect, a system includes a server executing instructions associated with a computing platform thereon, a power sink, a first data processing device associated with the power sink, with the first data processing device executing a first application thereon as a first component of the computing platform, and a mobile power source associated with a second data processing device executing a second application thereon as a second component of the computing platform. The server executing the instructions associated with the computing platform dynamically tracks a change in location of the mobile power source based on communication with the second application. The first application detects a level of charge remaining in a battery of the power sink, and, in response to the detection of the level of charge remaining in the battery of the power sink, identifies the mobile power source as compatible with the power sink based on the dynamically tracked change in the location of the mobile power source via the server. The server executing the instructions associated with the computing platform also automatically generates, through the first application, a transaction identifier identifying a service request from the first data processing device for charging or recharging the battery of the power sink through the mobile power source following the identification of the mobile power source as compatible with the power sink.

The methods and systems disclosed herein may be implemented in any means for achieving various aspects. Other features will be apparent from the accompanying drawings and from the detailed description that follows.

### BRIEF DESCRIPTION OF THE DRAWINGS

The embodiments of this invention are illustrated by way of example and not limitation in the figures of the accompanying drawings, in which like references indicate similar elements and in which:

FIG. 1 is a schematic view of a power charging system, according to one or more embodiments.

FIG. 2 is a schematic view of a smart mobile data processing device, according to one or more embodiments.

FIG. 3 is a schematic view of an exchange based battery power charge/recharge system, according to one or more embodiments.

FIG. 4 is a schematic view of a large scale exchange based battery power charge/recharge system, according to one or more embodiments.

FIG. 5 is a schematic view of a user interface of an application executing on a mobile data processing device associated with a power sink of FIGS. 2-4, according to one or more embodiments.

FIG. 6 is a schematic view of transactional verification at a mobile data processing device associated with a power source of FIGS. 3-5, according to one or more embodiments.

FIG. 7 shows a process flow diagram detailing the operations involved in a mobile battery charging/recharging service provided through a computing platform, according to one or more embodiments.

Other features of the present embodiments will be apparent from the accompanying drawings and from the detailed description that follows.

### DETAILED DESCRIPTION

Example embodiments, as described below, may be used to provide a method, a server and/or a system of a mobile battery charging/recharging service provided through a computing platform. It will be appreciated that the various embodiments discussed herein need not necessarily belong to the same group of exemplary embodiments, and may be grouped into various other embodiments not explicitly disclosed herein. In the following description, for purposes of explanation, numerous specific details are set forth in order to provide a thorough understanding of the various embodiments.

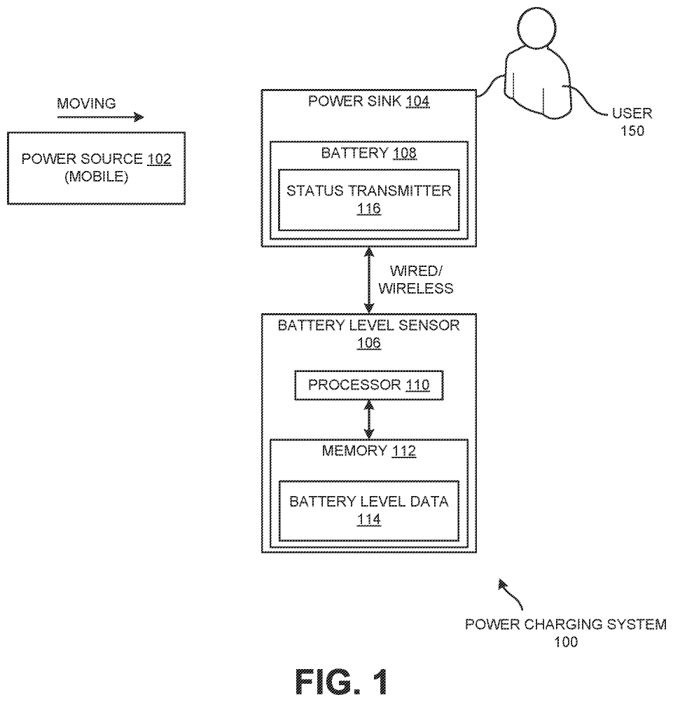

FIG. 1 shows a power charging system 100, according to one or more embodiments. In one or more embodiments, power charging system 100 may include a mobile (moving; e.g., portable, non-portable) power source 102 configured to charge a power sink 104 as per requirements thereof, according to one or more embodiments. In one or more embodiments, power source 102 alone may be mobile and power sink 104 may not be mobile. In some other embodiments, both power source 102 and power sink 104 may be mobile. It may be possible to envision a scenario where a person driving a vehicle (e.g., an electric car, a scooter, a bicycle) may view a battery level indicator (say, on a dashboard) and glean that the battery (e.g., rechargeable battery; example power sink 104; the vehicle may also be regarded as power sink 104) of the vehicle is about to drained of charge. Through the concepts discussed herein, said person may be able to recharge the car battery using the battery of another vehicle (e.g., in exchange for some monetary consideration payable by online means, electronic wallets, cryptocurrency, debit card and/or credit card). In another scenario, the driver of yet another vehicle may glean that the battery level is low and that the battery thereof is going to die soon. Said driver may be able to find a vehicle in proximity thereto to jumpstart the yet another vehicle in case of stalling thereof.

In yet another scenario, a person may be carrying a battery (e.g., a power bank) in a backpack thereof. Another person carrying a mobile phone may find out that the battery level thereof is low (e.g., remaining charge in the battery is low) and that he/she is without a phone charger. Thus, in one or more embodiments, the person carrying the battery in the backpack may enable the another person to charge his/her mobile phone in accordance with the discussion pertaining to the exemplary embodiments discussed herein. The charging cable(s)/jumper cable(s) may be part of a service provided by the person with power source 102 or may be available with the person with power sink 104. FIG. 1 also shows a battery level sensor 106 communicatively coupled to a battery 108 of power sink 104, according to one or more embodiments. In one or more embodiments, battery level sensor 106 may include a processor 110 (e.g., a processor or a set of processors, a microcontroller, a microprocessor) communicatively coupled to a memory 112 (e.g., a volatile and/or a non-volatile memory).

In one or more embodiments, processor 110 of battery level sensor 106 may receive battery level data 114 from battery 108 based on a wired and/or a wireless (e.g., based on short range communication protocols such as Bluetooth® and Wi-Fi®, based on long-range communication protocols; all forms of possible communication are within the scope of the exemplary embodiments discussed herein) form of communicative coupling therebetween. In one or more embodiments, a user 150 of power sink 104 may be apprised (e.g., constantly, periodically, based on threshold battery levels) of a charge level of battery 108 through battery level sensor 106/processor 110.

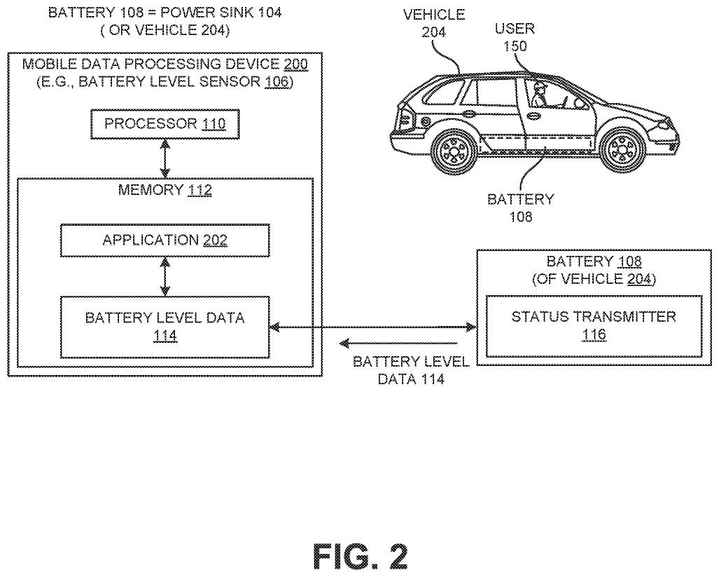

FIG. 2 shows a smart mobile data processing device 200 (e.g., a mobile device such as a mobile phone, a portable media player, a tablet), according to one or more embodiments. In one or more embodiments, mobile data processing device 200 itself may be power sink 104. In some other embodiments, mobile data processing device 200 may merely constitute battery level sensor 106 and may be communicatively coupled to power sink 104 (e.g., a car, a scooter, a motorbike, another mobile data processing device, a non-mobile data processing device) or battery 108. In one or more embodiments, mobile data processing device 200 may execute an application 202 on processor 110.

FIG. 2 shows application 202 stored in memory 112 to be executed through processor 110. FIGS. 1 and 2 both show memory 112 as including battery level data 114.

In the case of user 150 driving a vehicle including battery 108 (vehicle 204 is shown as including battery 108 in FIG. 2, and battery 108/vehicle 204 is shown as power sink 104 therein), mobile data processing device 200 may receive battery level data 114 from battery 108 through wired and/or wireless means. In one or more embodiments, for the aforementioned purpose, battery 108 may have a wireless communication component (e.g., a status transmitter 116) associated therewith (e.g., part of battery 108, communicatively coupled to battery 108) to communicate battery level data 114 to mobile data processing device 200/processor 110. In some embodiments, status transmitter 116 may be a wired interface couplable to mobile data processing device 200 and in some other embodiments, status transmitter 116 may be a wireless component (e.g., a transceiver) configured to communicate with mobile data processing device 200.

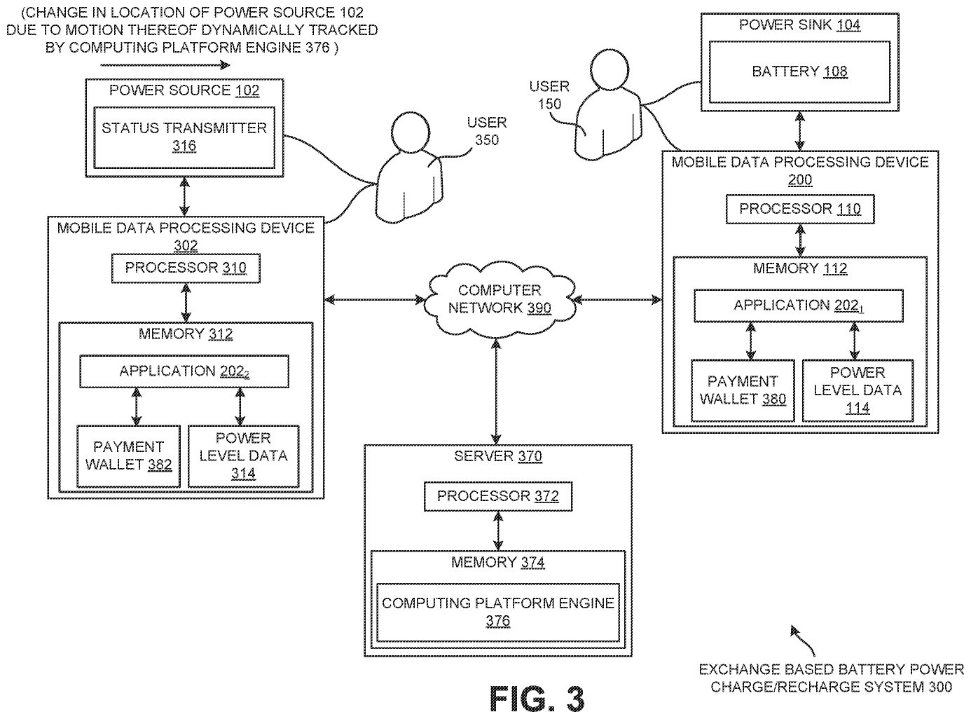

In one or more embodiments, the purpose of application 202 executing on wireless data processing device 200 may not merely be to track battery level data 114. In one or more embodiments, application 202 may form part of an exchange based battery power charge/recharge system 300, as shown in FIG. 3. In exchange based battery power charge/recharge system 300, power source 102 may be mobile (e.g., moving), as discussed above, and power sink 104 may be mobile or non-mobile (e.g., static), according to one or more embodiments. In one or more embodiments, power source 102 may have a mobile data processing device 302 associated therewith.

In one or more embodiments, mobile data processing device 302 may include a processor 310 communicatively coupled to memory 312; processor 310 and memory 312 may be analogous to processor 110 and memory 112 discussed above. In one or more embodiments, mobile data processing device 302 may also execute application 202₂ (e.g., application 202) therein; FIG. 3 shows mobile data processing device 302 executing application 202₂ and mobile data processing device 200 executing application 202₁ (e.g., application 202), where mobile data processing device 302 and mobile data processing device 200 are communicatively coupled to one another through a computer network 390 (e.g., a mobile network and/or a Wide Area Network (WAN), a Local Area Network (LAN) and/or a short-range computer communication network).

In one or more embodiments, power source 102 may also have a status transmitter 316 analogous to status transmitter 116; status transmitter 316 may transmit power level data 314 (e.g., stored in memory 312 in FIG. 3) to mobile data processing device 302 through wired and/or wireless means. In accordance therewith, a user 350 associated with power source 102 may ensure that power source 102 has the appropriate capacity to address demand from one or more mobile data processing devices (e.g., mobile data processing device 200). In one or more embodiments, user 350 may have the capacity to set a price for use of power source 102 by user 150 to recharge power sink 104. For the aforementioned purpose, in one or more embodiments, exchange based battery power charge/recharge system 300 may offer a computing platform in which a server 370 (e.g., one or more servers; a network of servers, a distributed network of servers) may track data from application 202₁ and application 202₂ in order to profile user 150 and user 350 and similar users.

In one or more embodiments, server 370 may include a processor 372 (e.g., a network of processors) communicatively coupled to a memory 374. In one or more embodiments, server 370 may execute a computing platform engine 376 (e.g., stored in memory 374 to be executable through processor 372) of which application 202₁ and application 202₂ executing on mobile data processing device 200 and mobile data processing device 302 respectively may merely be components. In one or more embodiments, computing platform engine 376 may be implemented such that user 350 (e.g., through mobile data processing device 302) may be able to receive a consideration (e.g., a payment) from user 150 (e.g., through mobile data processing device 200) in exchange for the charging/recharging service provided through power source 102. For the aforementioned purpose, in one or more embodiments, each of user 350 and user 150 may have a payment wallet 382 and payment wallet 380 respectively associated therewith.

Other forms of payment systems (e.g., credit/debit card integration, online banking integration, cryptocurrency) integrated with application 202₁ and application 202₂ are within the scope of the exemplary embodiments discussed herein. In one or more embodiments, power source 102 may be moving or currently be static and capable of moving soon. In one or more embodiments, a change in location of power source 102 due to motion thereof may be dynamically tracked by computing platform engine 376/server 370. It should be noted that changes in location of power sink 104 may also be dynamically tracked through computing platform engine 376/server 370. However, FIG. 3 shows dynamic tracking of the changes in location of power source 102 alone for the sake of relevance.

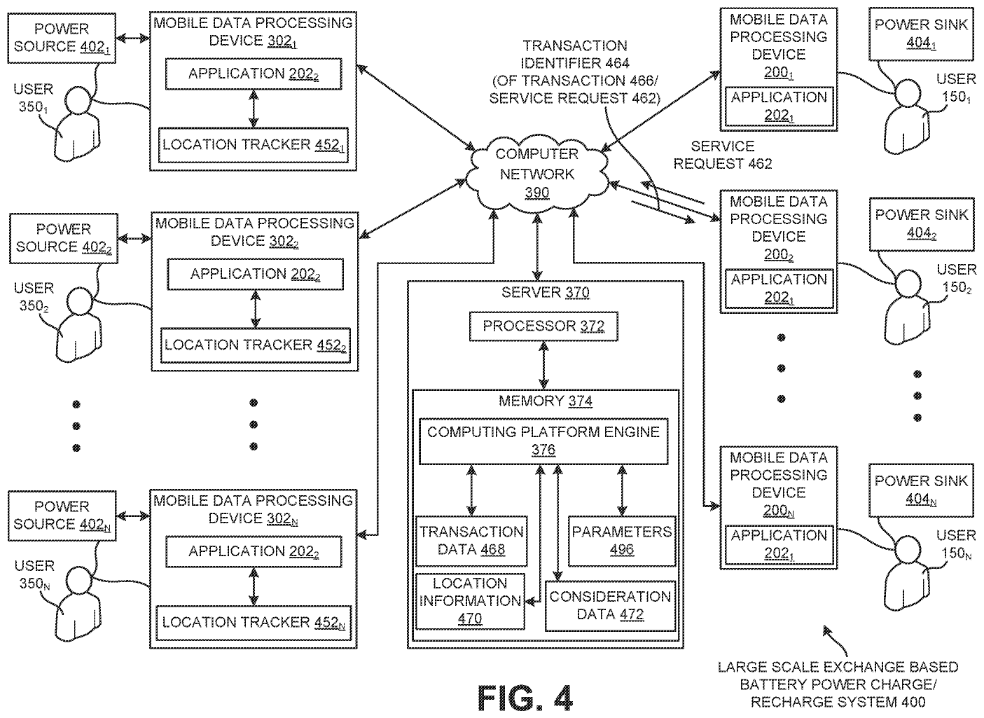

FIG. 4 shows a large scale exchange based battery power charge/recharge system 400 (e.g., implemented through a cloud based and/or a distributed computing system), according to one or more embodiments. In one or more embodiments, large scale exchange based battery power charge/recharge system 400 may include a number of power sources 402_{1-N} (e.g., including power source 102) communicatively coupled to a number of power sinks 404_{1-N} (e.g., including power sink 104). FIG. 4 shows each power source 402_{1-N} as associated with a user 350_{1-N} (e.g., including user 350) and a mobile data processing device 302_{1-N} (e.g., including mobile data processing device 302) and each power sink 404_{1-N} as associated with a user 150_{1-N} (e.g., including user 150) and a mobile data processing device 200_{1-N} (e.g., including mobile data processing device 200) for the sake of illustrative convenience; it should be noted that a user 350_{1-N}/150_{1-N} may be associated with more than one power source 402_{1-N}/power sink 404_{1-N} as appropriate. In one or more embodiments, server 370, mobile data processing devices 302_{1-N} and mobile data processing devices 200_{1-N} may be communicatively coupled to one another through computer network 390 discussed above. It should be noted that the number of power sources and the number of power sinks may be completely different. However, FIG. 4 shows the number of power sources and the number of power sinks to be the same merely for illustrative convenience.

In one or more embodiments, at the source level, power sources 402_{1-N} and/or mobile data processing device 302_{1-N} may each have a location tracker 452_{1-N} (e.g., captured by application 202₂ executing on mobile data processing device 302_{1-N}; location tracker 452_{1-N} may be Global Positioning System (GPS) coordinates) implemented therein that enables user 150_{1-N} view location information 470 (e.g., including changes in location dynamically tracked by computing platform engine 376/server 370) of power sources 402_{1-N} and/or mobile data processing devices 302_{1-N} through application 202₁ executing on mobile data processing device 200_{1-N} thereof. FIG. 4 shows memory 374 of server 370 as including location information 470 and consideration data 472 (monetary values assigned by users 350_{1-N} for use of power sources 402_{1-N}), according to one or more embodiments. In one or more embodiments, a subset of consideration data 472 may be set by user 350_{1-N} based on parameters such as duration of use, use of charging cables, level of charge required by power sinks 404_{1-N}, amount of energy required (e.g., in Kilowatt-hour (kWh)) and so on.

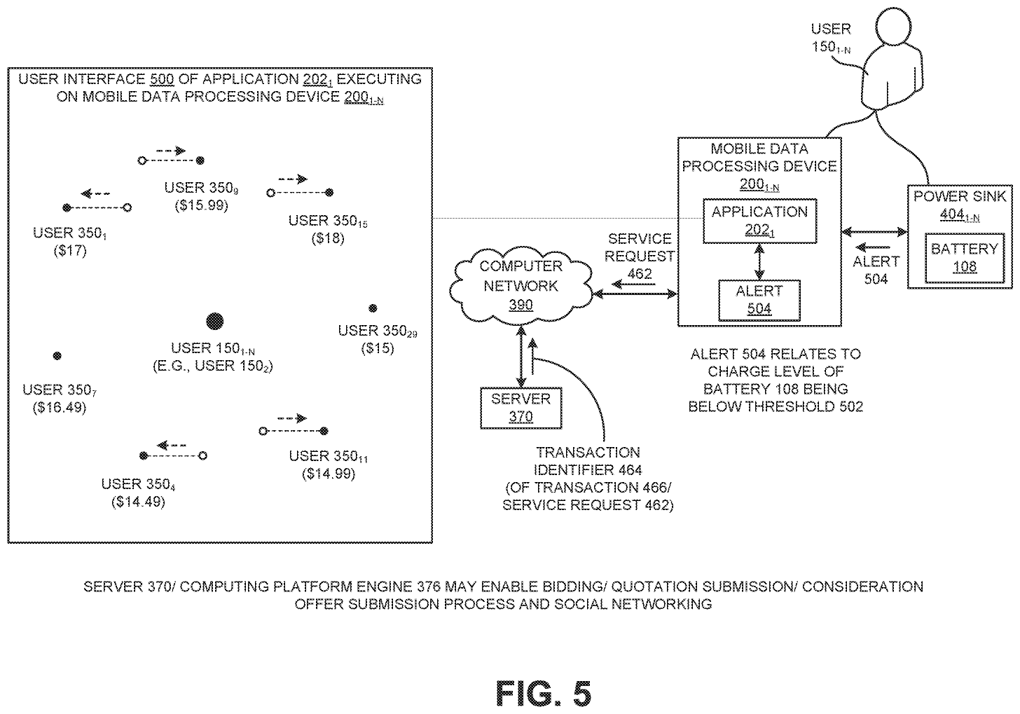

FIG. 5 shows a user interface 500 of application 202₁ executing on mobile data processing device 200_{1-N}, according to one or more embodiments. In one or more embodiments, when application 202₁ executing on mobile data processing device 200_{1-N} (e.g., mobile data processing device 200) detects from battery level data 114 that a charge level of battery 108 is below a threshold (e.g., threshold 502), user 150_{1-N} (e.g., user 150) may receive an alert 504 on mobile data processing device 200_{1-N}; alert 504 may be in the form of a vibration, a pre-recorded audio playing on mobile data processing device 200_{1-N} and/or an update; other forms of alert 504 are within the scope of the exemplary embodiments discussed herein. In one or more embodiments, alert 504 may apprise user 150_{1-N} with a status of battery 108. In response thereto, in one or more embodiments, user 150_{1-N} may open application 202₁ on mobile data processing device 200_{1-N} and view a subset of users 350_{1-N} filtered (e.g., automatically by computing platform engine 376) by appropriate power sources 402_{1-N} and location information 470 on user interface 500. In one or more embodiments, consideration data 472 associated with users 350_{1-N} may be tagged thereonto.

In other words, in one or more embodiments, computing platform engine 376 may enable dynamic population of user interface 500 with a list of users 350_{1-N} based on locational proximity to user 150_{1-N}; movement of users 350_{1-N}/power sources 402_{1-N} may also be dynamically tracked. In some embodiments, user interface 500 may be populated with users 350_{1-N} filtered based on a threshold distance (e.g., within 2 miles) away from user 150_{1-N}; for the aforementioned purpose, location information 470 (e.g., including dynamic changes in location) of users 350₁-N/power sources 402_{1-N} may be determined. In one or more embodiments, user 150_{1-N} may select a user 350_{1-N} based on satisfaction thereof with respect to compatibility of power source 402_{1-N} of user 350_{1-N} and consideration data 472 thereof. In one or more embodiments, once user 150_{1-N} selects user 350_{1-N}, computing platform engine 376 may automatically initiate a service request 462 on behalf of user 150_{1-N}. In one or more embodiments, once payment is completed in accordance with service request 462 via mobile data processing device 200_{1-N}, a transaction identifier 464 (e.g., a Quick Response (QR) code; other transaction identifiers are within the scope of the exemplary embodiments discussed herein) may automatically be generated by computing platform engine 376.

In one example implementation, directions (e.g., including maps) to a location of power source 402_{1-N} chosen may then be shown via application 202₁. Once user 150_{1-N} reaches the location of power source 402_{1-N}, the transaction (e.g., transaction 466) may be confirmed based on mobile data processing device 302_{1-N} reading transaction identifier 464. User 350_{1-N} may then provide the authorized service to user 150_{1-N}. In other implementations, user 350_{1-N} at power source 402_{1-N} may also have directions (e.g., in maps) shown via application 202₂ to user 150_{1-N}/mobile data processing device 302_{1-N}/power sink 404_{1-N}. Here, the option to increase consideration therefor may be contextually implemented.

In some embodiments, once the charge level of battery 108 is detected to be low (e.g., outside a threshold) through application 202₁, user 150_{1-N} may be automatically matched to a power source 402_{1-N} based on one or more parameters (e.g., parameters 496) such as device compatibility, costs, closest distance, ratings of user 350_{1-N} corresponding to power source 402_{1-N} on computing platform engine 376) and then transaction identifier 464 may be generated. Optionally, payment for transaction 466 may be completed and user 150_{1-N} may be led to the location of the chosen/identified power source 402_{1-N}. In one or more other embodiments, computing platform engine 376 may enable a bidding/quotation submission/consideration offer submission process to be initiated based on which either user 150_{1-N} or user 350_{1-N} (or both) may accept transaction 466. In one or more embodiments, as indicated above, computing platform engine 376 may also profile users 150_{1-N} and users 350_{1-N} based on requirements, usage history and/or other parameters, and/or may also enable social networking on large scale exchange based battery power charge/recharge system 400.

Further, in one or more embodiments, transaction data 468 (e.g., stored in memory 374) may enable computing platform engine 376 to refine positioning of users 350_{1-N} on user interface 500 of mobile data processing device 200_{1-N} and segment and/or match users 350_{1-N} to users 150_{1-N} better based on parameters such as prior use, ratings of users 350_{1-N} on the computing platform (e.g., computing platform engine 376), shared interests and so on. In some embodiments, Artificial Intelligence (AI)/Machine Learning (ML) algorithms may be implemented through computing platform engine 376 to enable adaptation thereof to new usage contexts. Al reasonable variations are within the scope of the exemplary embodiments discussed herein.

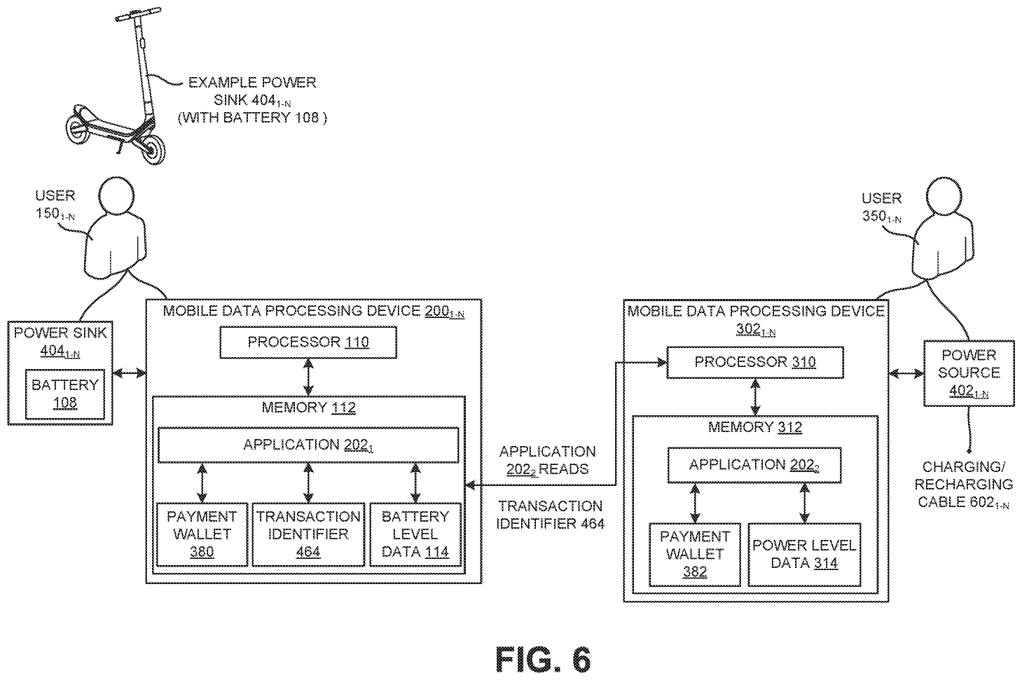

FIG. 6 shows transactional verification at mobile data processing device 302_{1-N} based on transaction identifier 464 generated through application 202₁ (e.g., via computing platform engine 376) at mobile data processing device 200_{1-N}, according to one or more embodiments. In one or more embodiments, transactional verification may be completed based on application 202₂ on mobile data processing device 302_{1-N} successfully reading transaction identifier 464. In one or more embodiments, user 350_{1-N} of mobile data processing device 302_{1-N} and power source 402_{1-N} associated therewith may then permit use of power source 402_{1-N} (and, optionally Universal Serial Bus (USB) or non-USB charging/recharging cables) for charging/recharging battery 108 of power sink 404_{1-N} (an example of which is an electric scooter, as shown in FIG. 6) associated with user 150_{1-N}. In some embodiments, mobile data processing device 302_{1-N} may be an automated drone or provided directly on power source 402_{1-N}, which also is mobile. Here, mobile data processing device 302_{1-N} may automatically read transaction identifier 464 and may enable access to power source 402_{1-N} upon successful reading thereof; in other words, mobile data processing device 302_{1-N} (e.g., application 202₂) may control access to power source 402_{1-N} and/or charging/recharging cable 602_{1-N} shown in FIG. 6. In one or more other embodiments, the charging/recharging of power sink 404_{1-N} may be done through wireless means via power source 402_{1-N}. Individual examples including but not limited to the ones discussed above, magnetic chargers and wireless charging pads are within the scope of the exemplary embodiments discussed herein.

It should be noted that, in one or more embodiments, power sink 404_{1-N} and mobile data processing device 200_{1-N} associated therewith may be the same, and the identified power source 402_{1-N} and mobile data processing device 302_{1-N} associated therewith may be the same. All reasonable variations are within the scope of the exemplary embodiments discussed herein. Thus, exemplary embodiments allow not only for the convenience of charging/recharging a vehicle (e.g., an electric scooter, an electric bike, a car) or any other example power sink 404_{1-N} but also enable a platform (e.g., a computing platform) for a battery charging/recharging service that covers the entire gamut of power sinks 404_{1-N} from electric vehicles of kids to larger vehicles to many other devices.

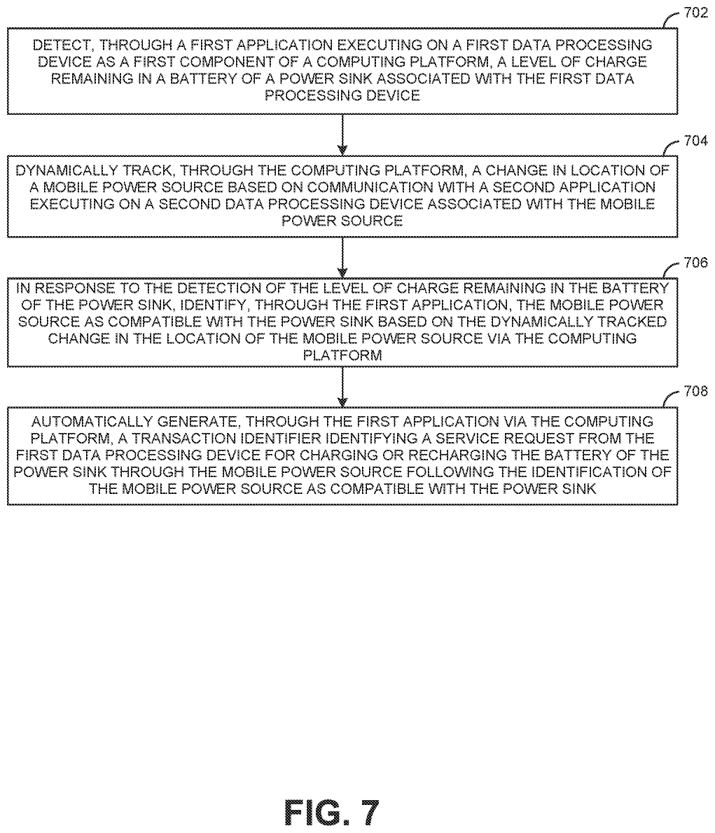

FIG. 7 shows a process flow diagram detailing the operations involved in a mobile battery charging/recharging service provided through a computing platform (e.g., computing platform engine 376), according to one or more embodiments. In one or more embodiments, operation 702 may involve detecting, through a first application (e.g., application 202₁) executing on a first data processing device (e.g., mobile data processing device 200_{1-N}) as a first component of the computing platform, a level of charge remaining in a battery (e.g., battery 108) of a power sink (e.g., power sink 404_{1-N}) associated with the first data processing device. In one or more embodiments, operation 704 may involve dynamically tracking, through the computing platform, a change in location of a mobile power source (e.g., power source 402_{1-N}) based on communication with a second application (e.g., application 202₂) executing on a second data processing device (e.g., mobile data processing device 302_{1-N}) as a second component of the computing platform, with the second data processing device being associated with the mobile power source.

In one or more embodiments, operation 706 may involve, in response to the detection of the level of charge remaining in the battery of the power sink, identifying, through the first application, the mobile power source as compatible with the power sink based on the dynamic tracking of the change in the location of the mobile power source via the computing platform. In one or more embodiments, operation 708 may then involve automatically generating, through the first application via the computing platform, a transaction identifier (e.g., transaction identifier 464) identifying a service request (e.g., service request 462) from the first data processing device for charging or recharging the battery of the power sink through the mobile power source following the identification of the mobile power source as compatible with the power sink.

Although the present embodiments have been described with reference to specific example embodiments, it will be evident that various modifications and changes may be made to these embodiments without departing from the broader spirit and scope of the various embodiments. For example, the various devices and modules described herein may be enabled and operated using hardware circuitry (e.g., CMOS based logic circuitry), firmware, software or any combination of hardware, firmware, and software (e.g., embodied in a non-transitory machine-readable medium). For example, the various electrical structures and methods may be embodied using transistors, logic gates, and electrical circuits (e.g., application specific integrated (ASIC) circuitry and/or Digital Signal Processor (DSP) circuitry).

In addition, it will be appreciated that the various operations, processes and methods disclosed herein may be embodied in a non-transitory machine-readable medium and/or a machine-accessible medium compatible with a data processing system (e.g., server 370, mobile data processing device 200_{1-N}, mobile data processing device 302_{1-N}). Accordingly, the specification and drawings are to be regarded in an illustrative rather than a restrictive sense.

What is claimed is:

1. A method comprising:
detecting, through a first application executing on a first data processing device as a first component of a computing platform, a level of charge remaining in a battery of a power sink associated with the first data processing device;
dynamically tracking, through the computing platform, a change in location of a mobile power source based on communication with a second application executing on a second data processing device as a second component of the computing platform, the second data processing device being associated with the mobile power source;
in response to the detection of the level of charge remaining in the battery of the power sink, identifying, through the first application, the mobile power source as compatible with the power sink based on the dynamically tracked change in the location of the mobile power source via the computing platform; and
automatically generating, through the first application via the computing platform, a transaction identifier identifying a service request from the first data processing device for one of: charging and recharging the battery of the power sink through the mobile power source following the identification of the mobile power source as compatible with the power sink.

2. The method of claim 1, further comprising reading, through the second application, the automatically generated transaction identifier to confirm the service request.

3. The method of claim 2, further comprising controlling, through the second application, access to at least one of: the identified mobile power source and a cable to complete the one of: the charging and the recharging of the battery of the power sink following the confirmation of the service request.

4. The method of claim 1, comprising identifying, through the first application, the mobile power source as compatible with the power sink based on at least one parameter comprising at least one of: a rating of a user associated with the identified mobile power source on the computing platform, a consideration charged by the user and a compatibility parameter of the identified mobile power source via the computing platform in addition to the dynamically tracked change in the location of the mobile power source via the computing platform.

5. The method of claim 1, further comprising one of:
alerting, via the first application, a user associated with the power sink of the detected level of charge remaining in the battery thereof to enable the user to trigger the identification of the mobile power source as compatible with the power sink; and
automatically identifying, through the first application, the mobile power source as compatible with the power sink in accordance with the detected level of charge remaining in the battery thereof falling outside a threshold.

6. The method of claim 1, comprising, identifying, through the first application, the mobile power source as compatible with the power sink based on one of: a bidding process, a consideration offer submission process and a quotation submission process implemented through the computing platform in addition to the dynamically tracked change in the location of the mobile power source via the computing platform.

7. The method of claim 1, comprising at least one of:
the power sink being one of: mobile and non-mobile;
the mobile power source being a portable mobile power source; and
performing the one of: the charging and the recharging of the battery at least one of: wirelessly and in a wired manner.

8. A server executing a computing platform comprising:
a memory comprising instructions associated with the computing platform stored therein; and
a processor communicatively coupled to the memory and executing the instructions associated with the computing platform to:
detect, through a first application executing on a first data processing device as a first component of the computing platform, a level of charge remaining in a battery of a power sink associated with the first data processing device;
dynamically track a change in location of a mobile power source based on communication with a second application executing on a second data processing device as a second component of the computing platform, the second data processing device being associated with the mobile power source;
in response to the detection of the level of charge remaining in the battery of the power sink, identify, through the first application, the mobile power source as compatible with the power sink based on the dynamically tracked change in the location of the mobile power source; and
automatically generate, through the first application, a transaction identifier identifying a service request from the first data processing device for one of: charging and recharging the battery of the power sink through the mobile power source following the identification of the mobile power source as compatible with the power sink.

9. The server of claim 8, further comprising the processor executing the instructions associated with the computing platform to confirm the service request based on reading, through the second application, the automatically generated transaction identifier.

10. The server of claim 9, further comprising the processor executing the instructions associated with the computing platform to enable controlling, through the second application, access to at least one of: the identified mobile power source and a cable to complete the one of: the charging and the recharging of the battery of the power sink following the confirmation of the service request.

11. The server of claim 8, further comprising the processor executing the instructions associated with the computing platform to identify the mobile power source as compatible with the power sink based on at least one parameter comprising at least one of: a rating of a user associated with the identified mobile power source on the computing platform, a consideration charged by the user and a compatibility parameter of the identified mobile power source in addition to the dynamically tracked change in the location of the mobile power source.

12. The server of claim 8, further comprising the processor executing the instructions associated with the computing platform to one of:
enable alerting, via the first application, a user associated with the power sink of the detected level of charge remaining in the battery thereof to enable the user to trigger the identification of the mobile power source as compatible with the power sink; and
enable automatic identification, via the first application, of the mobile power source as compatible with the power sink in accordance with the detected level of charge remaining in the battery thereof falling outside a threshold.

13. The server of claim 8, comprising the processor executing the instructions associated with the computing platform to identify the mobile power source as compatible with the power sink based on one of: a bidding process, a consideration offer submission process and a quotation submission process implemented through the computing platform in addition to the dynamically tracked change in the location of the mobile power source.

14. A system comprising:
a server executing instructions associated with a computing platform thereon;
a power sink;
a first data processing device associated with the power sink, the first data processing device executing a first application thereon as a first component of the computing platform; and
a mobile power source associated with a second data processing device executing a second application thereon as a second component of the computing platform,
wherein the server executing the instructions associated with the computing platform dynamically tracks a change in location of the mobile power source based on communication with the second application,
wherein the first application,
detects a level of charge remaining in a battery of the power sink, and
in response to the detection of the level of charge remaining in the battery of the power sink, identifies the mobile power source as compatible with the power sink based on the dynamically tracked change in the location of the mobile power source via the server, and
wherein the server executing the instructions associated with the computing platform also automatically generates, through the first application, a transaction identifier identifying a service request from the first data processing device for one of: charging and recharging the battery of the power sink through the mobile power source following the identification of the mobile power source as compatible with the power sink.

15. The system of claim 14, wherein the second application reads the automatically generated transaction identifier to confirm the service request.

16. The system of claim 15, wherein the second application controls access to at least one of: the identified mobile power source and a cable to complete the one of: the charging and the recharging of the battery of the power sink following the confirmation of the service request.

17. The system of claim 14, wherein the first application identifies the mobile power source as compatible with the power sink based on at least one parameter comprising at least one of: a rating of a user associated with the identified mobile power source on the computing platform, a consideration charged by the user and a compatibility parameter of the identified mobile power source via the computing platform in addition to the dynamically tracked change in the location of the mobile power source.

18. The system of claim 14, wherein the first application one of:
alerts a user associated with the power sink of the detected level of charge remaining in the battery thereof to enable the user to trigger the identification of the mobile power source as compatible with the power sink, and
automatically identifies the mobile power source as compatible with the power sink in accordance with the detected level of charge remaining in the battery thereof falling outside a threshold.

19. The system of claim 14, wherein the first application identifies the mobile power source as compatible with the power sink based on one of: a bidding process, a consideration offer submission process and a quotation submission process implemented through the computing platform in addition to the dynamically tracked change in the location of the mobile power source.

20. The system of claim 14, wherein at least one of:
the power sink is one of: mobile and non-mobile,
the identified mobile power source is a portable mobile power source,
the power sink and the first data processing device are the same,
the identified mobile power source and the second data processing device are the same, and
the one of: the charging and the recharging of the battery of the power sink is performed in at least one of: wirelessly and in a wired manner.
